(19) United States
(12) Patent Application Publication
(10) Pub. No.: US 2024/0396612 A1
(43) Pub. Date: Nov. 28, 2024

(54) TRANSCEIVER POINT BEAM FAILURE RECOVERY

(71) Applicant: NOKIA TECHNOLOGIES OY, Espoo (FI)

(72) Inventors: Timo KOSKELA, Oulu (FI); Samuli Heikki TURTINEN, Ii (FI); Chunli WU, Beijing (CN)

(21) Appl. No.: 18/694,345

(22) PCT Filed: Sep. 24, 2021
(86) PCT No.: PCT/CN2021/120497

§ 371 Date: Mar. 21, 2024

(51) Int. Cl. H04B 7/06; H04W 24/10

(52) U.S. Cl. CPC H04B 7/06964; H04W 24/10

(57) ABSTRACT

Embodiments of the present disclosure relate to devices, methods, apparatuses and computer readable storage media of TRP beam failure recovery. The method comprises determining a set of failed cells associated with the first device based on a beam failure detection; and generating a beam failure report indicating respective one or more failure detection resource sets associated with at least a portion of the set of failed cells. In this way, the UE may determine the information included in the BFR MAC CE in a case where the UL grant is not enough to include all the information for the failed serving cells or the BFR MAC to be transmitted on the MSG3 or MSGA in a CBRA procedure on the SpCell.

### FIELD

Embodiments of the present disclosure generally relate to the field of telecommunication and in particular to devices, methods, apparatuses and computer readable storage media of Transceiver Point (TRP) beam failure recovery.

### BACKGROUND

Currently, the support for multi-TRP beam failure recovery has been discussed. For example, the enhancement on support for multi-TRP deployment may comprises identifying and specifying features to improve reliability and robustness for channels other than PDSCH by using multi-TRP and/or multi-panel.

To enhance the current beam failure detection procedure to cover the multi-TRP operation, it has been agreed that multi-TRP Beam Failure Report (BFR) may use Secondary Cell (SCell) BFR as a baseline, i.e., a User Equipment (UE) can be configured with more than one Beam Failure Detection Resource Set (BFD-RS) sets per serving cell.

### SUMMARY

In general, example embodiments of the present disclosure provide a solution of TRP beam failure recovery.

In a first aspect, there is provided a method. The method comprises determining a set of failed cells associated with the first device based on a beam failure detection; and generating a beam failure report indicating respective one or more failure detection resource sets associated with at least a portion of the set of failed cells.

In a second aspect, there is provided a first device. The first device comprises at least one processor; and at least one memory including computer program codes; the at least one memory and the computer program codes are configured to, with the at least one processor, cause the first device at least to perform the method according to the first aspect.

In a third aspect, there is provided an apparatus comprising means for determining a set of failed cells associated with the first device based on a beam failure detection; and means for generating a beam failure report indicating respective one or more failure detection resource sets associated with at least a portion of the set of failed cells.

In a fourth aspect, there is provided a computer readable medium having a computer program stored thereon which, when executed by at least one processor of a device, causes the device to carry out the method according to the first aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a flowchart of an example method of TRP beam failure recovery according to some example embodiments of the present disclosure;

FIG. 3 shows an example of BFR according to some example embodiments of the present disclosure;

FIG. 4 shows a simplified block diagram of a device that is suitable for implementing example embodiments of the present disclosure; and

FIG. 5 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU a portion of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) a portion of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

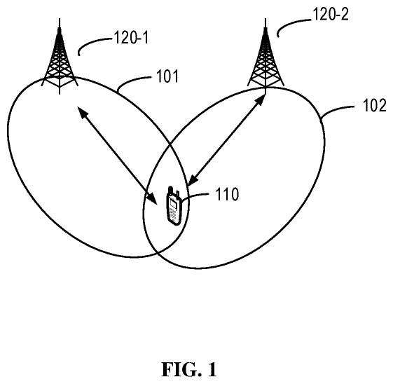

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise TRPs 120-1 and 120-2, which may communicate with the terminal device 110 within the coverage of cells 101 and 102, respectively. Hereinafter the TRP 120-1 may also be referred to as a first TRP 120-1 and the TRP 120-2 may also be referred to as a second TRP 120-2. It is to be understood that TRPs 120-1 and 120-2 may comprise of one or more TRPs.

It is to be understood that the number of network devices and terminal devices shown in FIG. 1 is given for the purpose of illustration without suggesting any limitations. The communication network 100 may include any suitable number of network devices and terminal devices.

As described above, the enhancement on beam failure detection procedure to cover the multi-TRP operation has been discussed.

It has been agreed that the BFR information for failed TRP can be provisioned using a Media Access Control Control Element (MAC CE). A failure of a TRP (and TRP may refer to one or more TRPs) may be determined based on the failure of beam failure detection reference signals in beam failure detection reference signal set or a resource set. In some example embodiments, the failure detected on a TRP may refer to a failure detected on the reference signals associated with the TRP. However, it is to be understood that in any of the embodiments herein, the reference signals in one resource set (beam failure detection resources in a resource set) may be transmitted by one or more TRPs. In some embodiments, there may be one or more beam failure detection resource sets per each serving cell, which may be referred to as a Primary Cell (PCell) or a Secondary Cell (SCell). A Scheduling Request (SR) (or up to 2) can be configured for the UE and the UE may use the SR to indicate a failure of at least one of the TRPs (i.e., Beam Failure Detection Resource Sets (BDF-RSs)). As a response network device may schedule UE an Uplink (UL) grant for provision of a BFR MAC CE for recovering the TRP.

In any of the embodiments herein the ‘TRP’ and ‘a BDF-RS’ may be used inter-changeably.

In any of the embodiments herein the multi-TPR operation and beam failure recovery thereof may refer to intra-cell deployment or inter-cell deployment. In the inter-cell multi-TRP operation, the UE may be configured with at least one Control Resource Set (CORESET) that has active Transmission Configuration Indicator (TCI) State for Physical Downlink Control Channel (PDCCH) reception (i.e. the RS indicated by the active TCI state is used as reception assumption for the PDCCH) that is associated with and cell identifier (i.e., Physical Cell Identifier (PCI), or an index value associated with the PCI) different from the serving cell.

In some embodiments, the UE may be configured with inter-cell beam management operation where the UE may be configured to receive and transmit from/to from a cell with a different cell identifier than the serving cell while still being served by the UE's serving cell (i.e. the serving cell may not change same although UE is configured to receive/transmit signals/channels from cell with different cell identifier than serving cell).

The size of the UL grant is typically small and the network device may not have knowledge on the amount of information that the UE would need to send, if multiple cells associated with the UE have failed TRP. Thus, the UE may not be able to provide full MAC CE.

In addition, the BFR MAC CE for multi-TRP recovery can also be transmitted on any available UL grant without SR and the grant may not be sufficient to accommodate the full BFR MAC.

The BFR MAC CE may also be transmitted using Contention Based Random Access (CBRA). However, the grant size for Message A (MSGA)/Message 3 (MSG3) is typically set to very minimum. When the UE initiates BFR procedure using CBRA for Special Cell (SpCell) and intends to indicate the BFR MAC CE in the MSGA/MSG3 grant, even the truncated BFR MAC CE would not fit within the 56 bits MSGA/MSG3 grant when 4 octet bitmap is used. Hereinafter the Special Cell (SpCell) may comprise one of the Primary Cell (PCell) or Primary Secondary Cell (PSCell).

Based on the above-mentioned situation, it has been defined that the truncated BFR MAC CE may indicate the network device that the UE may transmit only a portion of the information in the MAC CE. Furthermore, it has also been defined that the UE may include as much data as possible for the UL while not exceeding the UL grant by maximizing the number of Secondary Cells (SCells) to be reported and including the in them ascending order (of the serving cell index/identifier).

The ascending order can be considered as feasible solution for the SCell BFR in Release 16, since all the SCells configured with BFR have similar failure detection in terms of number of BFD-RS sets. However, in Release 17, the UE may have configuration for TRP specific beam failure detection, i.e., such detection may be configured on serving cell basis and thus it is expected that following configurations can be supported for each serving cell configured for beam failure detection in Release 17, namely a serving cell is configured for TRP specific failure detection and both TRPs fail and a serving cell is not configured TRP specific failure but for legacy failure detection.

Based on the configuration, one serving cell may be configured with TRP specific failure while the other serving cell may be configured with cell level failure detection. In this situation, it may not be feasible to list the failed serving cells in ascending order as the failure situation may be different for each failed serving cell.

It is to be discussed how to determine the information that is included in the truncated BFR MAC CE for multi-TRP beam failure recovery when the UL grant cannot accommodate full information or in the BFR MAC CE for multi-TRP is transmitted on MSG3 or MSGA.

Therefore, the present disclosure provides solutions of TRP beam failure recovery. In this solution, the UE may determine a set of failed cells associated with the first device based on a beam failure detection. Furthermore, the UE may generate a beam failure report (such as beam failure recovery request) indicating respective resource sets associated with the set of failed cells. The respective resource sets may be corresponding to one or more transceiver points configured for respective one of failed cells in the set of failed cells. In this way, the UE may determine the information included in the BFR MAC CE in a case where the UL grant is not enough to include all the information for the failed serving cells or the BFR MAC to be transmitted on the MSG3 or MSGA in a CBRA procedure on the SpCell.

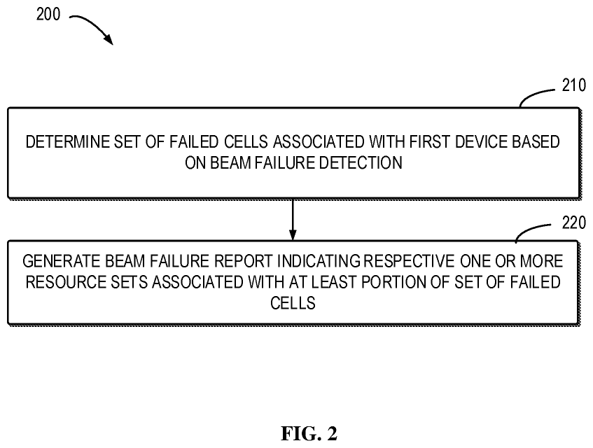

Principle and implementations of the present disclosure will be described in detail below with reference to FIG. 2, which shows a flowchart of an example method 200 of TRP beam failure recovery according to some example embodiments of the present disclosure. The method 200 can be implemented at the UE 110 as shown in FIG. 1. For the purpose of discussion, the method 200 will be described with reference to FIG. 1.

In a beam failure recovery procedure, the UE may perform a Beam Failure Detection (BFD) for the serving cells of the UE 110. At 210, the UE 110 may determine a set of failed cells from the serving cells based on the result of the beam failure detection.

At 220, the UE 110 may generate a beam failure report which may indicate respective one or more failure detection resource sets (BFD-RS sets) associated with at least a portion of the set of failed cells.

In some example embodiment, the BFD-RS sets may be identified based on an index associated with the BFD-RS set. In the beam failure recovery request (BFR MAC CE, beam failure report or the like), the failed BFD-RS set (index) may be indicated using a bit field with specific value (for example, ‘0’ for no failure and ‘1’ for failure or vice versa).

In some example embodiments, the octet containing the AC field indicates the associated BFD-RS set implicitly i.e. when two octets are included in the MAC CE, there is a respective containing the AC field for failed BFD-RS set. As an example, for the failed servCellIndex, the failed BFD-RS set with first index value is listed first in the MAC CE and the failed BFD-RS set with second index value is listed second in the MAC CE. In this way the octet position encodes the BFD-RS set index value and the octet containing the AC field is associated with respective BFD-RS set. In another example, if only one octet is present in the MAC CE, a bit field in the octet may indicate the failed BFD-RS set. Alternatively, in case only one octet is present the octet corresponds to the octet containing the AC filed that is associates to specific BFD-RS set index value (e.g. BFD-RS set with first value or second value).

In any of the example embodiments herein, the octet containing the AC field may not be limited to a byte (8 bits) and the information field to provide candidate beam information/beam failure recovery information associated with the failed BFD-RS set (or TRP) may have length of 2 octets or in general, N-bit length (N=1, 2, 3, 4 . . . bits).

In some example embodiments, the UE 110 may determine a respective first failed failure detection resource set for each of the set of failed cells and generate the BFR based on the determined first failed failure detection resource sets.

For example, in a case where the octets containing the Available Candidate (AC) field, if present, are included in ascending order based on the ServCellIndex and only single octet containing the AC field per serving cell is included, one bit in the octet containing the AC field may encode the failed BFD-RS set identifier. For example, if the TRP 120-1 and TRP 120-2 may be referred to as TRP 0 (BFD-RS set #0) and TRP 1 (BFD-RS set #1), the encoded failed BFD-RS set identifier may be 0 or 1.

In some example embodiments, the determined failed failure detection resource set(s) to be reported in the BFR may be selected based on the resource set containing the RS associated with lowest Control Resource Set (CORESET) index or contain the RS with lower identifier. As an example, if BFD-RS set #0 includes RS that is associated with a CORESET with index #0 and if BFD-RS #1 set includes RS that is associated with CORESET with index #1, the failure indication for BFD-RS set #0 is prioritized.

In some example embodiments, if one octet containing the AC field per failed serving cell is included in the BFR information, the UE may not include any further octets containing the AC field for any failed serving cell in the BFR information. As an example, if for some serving cell the both BFD-RS sets have failed (or more than one BFD-RS set has failed), UE includes only one octet containing the AC field corresponding to the one failed RS set.

In some example embodiments, if one octet containing the AC field per failed serving cell is included in the BFR information, UE determines to include the information on BFD-RS set with lower identifier value (e.g. in case there are 2 sets of BFD-RS with identifiers 0 and 1 and both sets have failed). In some example embodiments, if one octet containing the AC field per failed serving cell is included in the BFR information UE indicates the information on the BFD-RS set that is associated with the serving cell. As an example, in inter-cell multi-TRP and/or inter-cell beam management the BFD-RS set may be associated with a cell with a different identifier than serving cell i.e. UE performs beam failure detection on the serving cell and one another cell. The cell with different identifier than serving cell may be a portion of the serving cell configuration.

In some example embodiments, the UE 110 may determine a respective first failed failure detection resource set for each of the set of failed cells. If a subset of failed cells in the set of failed cells are detected with more than one failed failure detection resource sets, the UE 110 may determine a respective second failed failure detection resource set for at least a portion of the subset of failed cells. The determined second failed failure detection resource sets are different from the determined first failed failure detection resource sets. Then the UE 110 may generate the BFR based on the determined first and second failed failure detection resource sets.

For example, in a case where the octets containing the AC field, if present, are included in ascending order based on the ServCellIndex and single octet containing the AC field per serving cell is included and if at least serving cell has detected failure for more than one failed BFD-RS, the UE may include the second octet containing in the ascending order of serving cell index.

In this case, one candidate beam octet associated with one failed BFD-RS is listed first per serving cell. In this first round of included octets, one bit in the octet containing AC field may indicate the failed BFD-RS set associated with a corresponding TRP.

Then, if a portion of serving cells have been detected with more than one failed BFD-RS set, one bit may indicate whether the “other/another” failed BFD-RS set was included in the first round of included octets.

In some example embodiments, for each reported cell, one bit in the octet containing the AC field may indicate whether second byte (AC field octet) follows the first indicated octet containing the AC field.

In some example embodiments, the BFR information (such as the MAC CE) may also comprise one bit used the octet containing AC to indicate if one or both BFD-RS sets failed in the cell. This information may be present per serving cell that has been indicated with failure in the MAC CE.

In some example embodiments, the failure information of the BFD-RS set associated with lower CORESET index or with lowest CORESET index (associated in a manner e.g. that BFD-RS set includes the RS indicated by the activated TCI state for the CORESET) may be indicated in the first round of included octets. As an option, if in this case the BFD-RS set with lower index/lowest CORESET index has not failed, the AC bit may indicate “no candidate” and follows a bit indicating that no failure was detected for this BFD-RS set.

In some example embodiments, the failure information of the second BFD-RS set may be indicated after the failure information of the first BFD-RS set based on the available grant size. As an option, the failure information of the second BFD-RS set could be included in ascending/descending order of the serving cell ID. Alternatively or additionally, the failure information of SpCell or PUCCH SCell may be prioritized. As an example, if serving cells SCell1 and SCell2 fail (one or two BFD-RS set fail for the serving cells) and SCell1 is a PUCCH SCell (i.e. it has an uplink at least for PUCCH transmission) the failure information on SCell 1 is included with priority over SCell 2. As another example, all the failed BFD-RS sets (e.g., one or two) of SpCell are always prioritized over the failure information of other cell(s), like SCell(s).

In some example embodiments, UE may include two octets with AC field for the serving cell (for respective failed BFD-RS sets) if the cell is an SpCell (and both BFD-RS sets have failed). For any failed SCell that is indicated, UE may include only one octet with AC field.

In some example embodiments, the UE 110 may determine a respective first resource set for each of the set of failed cells and a respective second resource set for at least a portion of the set of failed cells if more than one TRPs are configured for respective one of failed cells. The UE 110 may generate the beam failure report based on the determined first and second resource sets.

For example, in a case where the octets containing the AC field, if present, are included in ascending order based on the ServCellIndex and two octets containing AC fields (or only one octet if the said ServCellIndex has one BFD-RS set) are included regardless of the failure status of the second TRP. In a case that two octets for a ServCellIndex cannot be included (e.g. due to size limitation i.e. the amount of information is already maximized) UE includes only one octet containing AC field. The included octet may be the octet containing the AC field for BFD-RS set with first value (or alternatively the set with second value). The one included octet may encode the index value of the failed BFD-RS set. Alternatively, in a case that two octets for a ServCellIndex cannot be included, both octets with AC field are omitted. In a case where both octets containing the AC field cannot be included, information of a failed ServCellIndex with one octet containing AC filed may be included.

In this case, a first BFD-RS set associated with one TRP may be included first and a second BFD-RS set associated with the other TRP may be included second per failed serving cell.

In some example embodiments, one bit in the octet containing the AC field may indicate whether the first and/or second BFD-RS set has failed or not.

In some example embodiments, the second octet containing AC field for the second BFD-RS set for any serving cell is included only after the first octet containing AC field has been encoded for all the failed serving cells. In this situation, in the first octet containing AC field, one bit may be used to indicate which BFD-RS set is indicated first. In the second octet containing AC field, one bit may be used to indicate if the second BFD-RS set also failed.

In some example embodiments, the second octet for the failed serving cells may be included per prioritization rules. For example, the second octet for the failed serving cells may be included based on serving cell ID in descending/ascending order. It is also possible that BFD-RS sets associated with certain type of failed cell may be included priority to other BFD-RS sets. For example, SpCell, PUCCH SCell or SCells with configured UL can be prioritized.

In some example embodiments, the UE 110 may determine a respective first failed failure detection resource set for at least a portion of the set of failed cells and generate the beam failure report based on the determined first failed failure detection resource sets. For example, in a case where the octets containing the AC field, if present, are included in ascending order based on the ServCellIndex and only single octet containing the AC field per serving cell is included, SCells with PUCCH may be prioritized over SCells without PUCCH.

In some example embodiments, in a case where the octets containing the AC field, if present, are included in ascending order based on the ServCellIndex and only octets containing the AC fields per serving cell is included for the cells that have failure of both TRPs or have been configured with one BFR-RS set only. In this case, as an option, the serving cells with multi-TRP BFR configuration have both candidate beam octets included. As another option, the serving cells with multi-TRP BFR (e.g. cells with more than one CORESETpoolindex values) configuration have one candidate beam octet included indicating failure of a BFD-RS set with lower set identifier.

In some example embodiment, the multi-TRP configuration may refer to cells configured with more than one CORESETpoolindex values.

In some example embodiment, the multi-TRP BFR configuration may refer to cells configured with more than one CORESETPoolIndex values and the BFD-RS sets are associated with the CORESETPoolindex values.

In some example embodiments, the field for indicating the failed cells in the BFR may indicate all the serving cells that have either BFD-RS set specific (one of the BFD-RS sets of a cell fail) or cell-specific (both BFD-RS sets fail, or both BFD-RS sets fail and no candidates available or cell is configured with only one BFD-RS set) beam failure detected.

In some example embodiments, the serving cell(s) with only cell-specific BFR are prioritized over the serving cells with multi-TRP configured when reporting truncated BFR. the field for indicating the failed cells may indicate only the cells reported since otherwise the network would not be able to identify the prioritized cells. The network knows there are other cell(s) failed that are not reported via a different LCID for truncated multi-TRP BFR than normal multi-TRP BFR, and as in legacy BFR for those cells remain triggered.

In some example embodiments, the generated BFR may be transmitted for failed SpCell in MSG 3/MSG A.

For example, the BFR MAC CE can be included in MSG 3/MSG A only in case both BFD-RS resource sets failed in SpCell or when the TRP linked to SpCell failed in case of inter-cell multi-TRP. Due to occurrence of RACH, the network may deduce from the BFR MAC CE in MSG3/MSGA already that both BFD-RS resource sets of SpCell have failed.

In some example embodiments, the BFD-RS set with lowest CORESET index is included in the AC octet if candidate is available. If no candidate available, the BFD-RS set with higher CORESET index may be included. In this case, one bit in the octet containing the AC field may encode the information of the failed TRP/BFD-RS index.

If there are no candidates available for either of the failed BFD-RS Sets, the bit in the octet containing AC field is set to 1 to indicate failure of BFD-RS resource set 1 and the AC field is set to indicate that no candidate is available. Therefore, the network may be indicated that no candidate from the candidate beam RS lists is available for either of the BFD-RS resource sets and the SSB selected for CBRA is the new candidate beam.

In some example embodiments, the BFR MAC CE may also comprise a Logical Channel Identification (LCID) identifying the MAC CE for multi-TRP BFR. The LCID may indicate whether the MAC CE is a truncated or non-truncated.

In some example embodiments, the LENGTH field may also be included in the BFR MAC CE in a case where the MAC CE is not a fixed size CE.

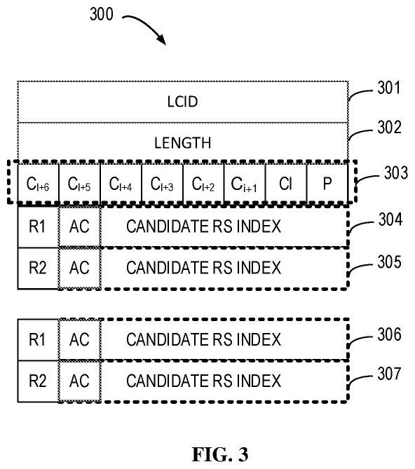

FIG. 3 shows an example of BFR according to some example embodiments of the present disclosure. As shown in FIG. 3, the MAC CE structure 300 for the BFR may comprise a LCID field 301, which may indicate whether the MAC CE is a truncated or non-truncated. The MAC CE structure 300 may also comprise a LENGTH field 302, which may be included in case the MAC CE is not a fixed size CE.

The MAC CE structure 300 may also comprise a field indicating the failed cells 303, which may also be referred to as serving cell index octet. The serving cell index octet may identify the failed serving cell when the corresponding bit is set to a value indicating that a failure is detected. For example, the bit field is set to 1 for failure and the bit field is set to 0 for non-failure. In some example embodiments, the field 303 could be 4 octets as well when the highest ServCellIndex of failed/reported serving cell is larger than 8.

As shown in FIG. 3, a candidate beam octet per TRP (BFD-RS set) is shown and octets may be present per serving cell. It is to be understood that the MAC CE structure shown in FIG. 3 may be referred to as a non-limiting implementation example for multi-TRP BFR MAC CE.

In the MAC CE structure 300 of FIG. 3, two candidate beam information fields may be included for each serving cell. For example, candidate beam information fields 304 and 305 are included for a serving cell and candidate beam information fields 306 and 3057 are included for another serving cell.

In the candidate beam information fields, R1 field may be referred to as reserved bit and the AC field may be referred to as available candidate. The candidate RS index may be referred to as index of the identified candidate beam if suitable candidate is found.

In some example embodiments, the R1 bit may also be used to indicate whether the first beam has failed and R2 bit is used to indicate whether the second beam has failed.

In some example embodiments, the R1 bit may also be used to indicate whether the second TRP has beam failure. The second octet for the serving cell can be omitted if R1 indicates 0, which means the second TRP has not failed.

For a serving cell configured with only cell-specific BFR, R bit is reserved or set to 0, which means only one AC/candidate RS index octet for the serving cell.

In some example embodiments, an apparatus capable of performing the method 200 (for example, implemented at the first device 110) may comprise means for performing the respective steps of the method 200. The means may be implemented in any suitable form. For example, the means may be implemented in a circuitry or software module.

In some example embodiments, the apparatus comprises means for determining a set of failed cells associated with the first device based on a beam failure detection; and means for generating a beam failure report indicating respective one or more failure detection resource sets associated with at least a portion of the set of failed cells.

FIG. 4 is a simplified block diagram of a device 400 that is suitable for implementing embodiments of the present disclosure. The device 400 may be provided to implement the communication device, for example the UE 110 as shown in FIG. 1. As shown, the device 400 includes one or more processors 410, one or more memories 440 coupled to the processor 410, and one or more communication modules 440 coupled to the processor 410.

The communication module 440 is for bidirectional communications. The communication module 440 has one or more communication interfaces to facilitate communication with one or more other modules or devices. The communication interfaces may represent any interface that is necessary for communication with other network elements. In some example embodiments, the communication module 440 may include at least one antenna.

The processor 410 may be of any type suitable to the local technical network and may include one or more of the following: general purpose computers, special purpose computers, microprocessors, digital signal processors (DSPs) and processors based on multicore processor architecture, as non-limiting examples. The device 400 may have multiple processors, such as an application specific integrated circuit chip that is slaved in time to a clock which synchronizes the main processor.

The memory 420 may include one or more non-volatile memories and one or more volatile memories. Examples of the non-volatile memories include, but are not limited to, a Read Only Memory (ROM) 424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 422 and other volatile memories that will not last in the power-down duration.

A computer program 430 includes computer executable instructions that are executed by the associated processor 410. The program 430 may be stored in the ROM 420. The processor 410 may perform any suitable actions and processing by loading the program 430 into the RAM 420.

The embodiments of the present disclosure may be implemented by means of the program 430 so that the device 400 may perform any process of the disclosure as discussed with reference to FIGS. 2 to 3. The embodiments of the present disclosure may also be implemented by hardware or by a combination of software and hardware.

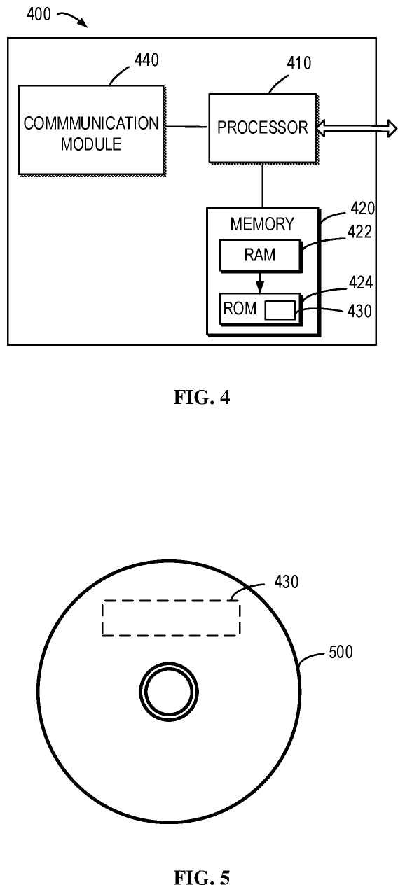

In some example embodiments, the program 430 may be tangibly contained in a computer readable medium which may be included in the device 400 (such as in the memory 420) or other storage devices that are accessible by the device 400. The device 400 may load the program 430 from the computer readable medium to the RAM 422 for execution. The computer readable medium may include any types of tangible non-volatile storage, such as ROM, EPROM, a flash memory, a hard disk, CD, DVD, and the like. FIG. 5 shows an example of the computer readable medium 500 in form of CD or DVD. The computer readable medium has the program 430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200 as described above with reference to FIG. 2. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method comprising:
determining a set of failed cells associated with the first device based on a beam failure detection; and
generating a beam failure report indicating respective one or more failure detection resource sets associated with at least a portion of the set of failed cells.

2. The method of claim 1, wherein generating the beam failure report comprises:
determining a respective first failed failure detection resource set for each of the set of failed cells; and
generating the beam failure report based on the determined first failed failure detection resource sets.

3. The method of claim 2, wherein the determined first failed failure detection resource sets are associated with a set of control resource sets having indices lower than a threshold number.

4. The method of claim 2, wherein the determined first failed failure detection resource sets have identifiers lower than a threshold number.

5. The method of claim 1, wherein generating the beam failure report comprises:
determining a respective first failed failure detection resource set for each of the set of failed cells;
in accordance with a determination that a subset of failed cells in the set of failed cells are detected with more than one failed failure detection resource sets, determining a respective second failed failure detection resource set for at least a portion of the subset of failed cells, the determined
second failed failure detection resource sets being different from the determined first failed failure detection resource sets; and
generating the beam failure report based on the determined first and the second failed failure detection resource sets.

6. The method of claim 5, wherein the beam failure report includes an indication whether the determined second failed failure detection resource sets are failed to be included after the first failed failure detection resource sets have been determined.

7. The method of claim 5, wherein the beam failure report includes an indication whether a single failure detection resource set or more than one failure detection resource sets for one failed cell in the set of failed cells are failed.

8. The method of claim 5, wherein the determined first failed failure detection resource sets are associated with a set of control resource sets having indices lower than a threshold number.

9. The method of claim 5, wherein the determined first failed failure detection resource sets have identifiers lower than a threshold number.

10. The method of claim 5, further comprising:
determining the respective second failed failure detection resource set for at least a portion of the subset of failed cells based on indices of the subset of failed cells and a grant size for the beam failure report.

11. The method of claim 5, further comprising:
determining the respective second failed failure detection resource set for at least a portion of the subset of failed cells based on cell types of the subset of failed cells and a grant size for the beam failure report.

12. The method of claim 1, wherein generating the beam failure report comprises:
in accordance with a determination that more than one transceiver points (TRPs) are configured for respective one of failed cells, determining a respective first failure detection resource set for each of the set of failed cells and a respective second failure detection resource set for at least a portion of the set of failed cells; and
generating the beam failure report based on the determined first and second failure detection resource sets.

13. The method of claim 12, wherein the beam failure report includes respective indications whether the determined first and second failure detection resource set are failed.

14. The method of claim 12, wherein the beam failure report includes an indication of identifiers for the determined first failure detection resource sets.

15. The method of claim 12, wherein the beam failure report includes respective indications whether the determined second failure detection resource sets are failed.

16. The method of claim 12, wherein determining the respective second failure detection resource set for the at least a portion of the set of failed cells comprises:
determining a portion of failed cells from the set of failed cells based on at least one of the following:
indices of the set of failed cells, or
cell types of the set of failed cells; and
determining the respective second failure detection resource set for each of the portion of failed cells.

17. The method of claim 1, wherein generating the beam failure report comprises:
determining the portion of the set of failed cells based on cell types of the set of failed cells;
determining a respective first failed failure detection resource set for the portion of the set of failed cells; and
generating the beam failure report based on the determined first failed failure detection resource sets.

18. The method of claim 1, wherein determining the portion of the set of failed cells comprises:
in accordance with a determination that more than one failure detection resource sets are associated with each of at least one failed cell and the more than one failure detection resource sets associated with each of at least one failed cell are failed, determining the at least one failed cell as the portion of the set of failed cells.

19. The method of claim 1, wherein determining the portion of the set of failed cells:
in accordance with a determination that a single failure detection resource set is associated with each of at least one failed cell, determining the at least one failed cell as the portion of the set of failed cells.

20. The method of claim 1, wherein determining the portion of the set of failed cells comprises:
determining the portion of the set of failed cells based on a type of the beam failure detection.

21. The method of claim 20, further comprising:
in accordance with a determination that more than one beam failure detection resource sets associated with a failed cell of the first device are failed and the failed cell is special cell of
the first device, transmit the beam failure report in a message of a random access procedure.

22. The method of claim 21, wherein generating the beam failure report comprises:
determining a failed failure detection resource set from a plurality of failed failure detection resource sets associated with more than one beam failure detection resource sets based on control resource set indices associated with the plurality of failed failure detection resource sets; and
generating the beam failure report based on the determined failed failure detection resource set.

23. A first device comprising:
at least one processor; and
at least one memory including computer program codes;
the at least one memory and the computer program codes are configured to, with the at least one processor, cause the first device at least to perform:
determining a set of failed cells associated with the first device based on a beam failure detection; and
generating a beam failure report indicating respective one or more failure detection resource sets associated with at least a portion of the set of failed cells.

24. (canceled)

25. A non-transitory computer readable medium comprising program instructions for causing an apparatus to perform:
determining a set of failed cells associated with the apparatus based on a beam failure detection; and
generating a beam failure report indicating respective one or more failure detection resource sets associated with at least a portion of the set of failed cells.
